(19) United States
(12) Patent Application Publication
(10) Pub. No.: US 2007/0189034 A1
(43) Pub. Date: Aug. 16, 2007

(54) High output light guide panel, backlight unit having the light guide panel, and display having the backlight unit

(75) Inventors: Young-chan Kim, Suwon-si (KR); Jee-hong Min, Yongin-si (KR); Seung-ho Nam, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/598,602

(22) Filed: Nov. 14, 2006

(30) Foreign Application Priority Data
Feb. 13, 2006 (KR) 10-2006-0013701
Apr. 19, 2006 (KR) 10-2006-0035364

(51) Int. Cl. F21V 7/04

(52) U.S. Cl. 362/607; 362/620

(57) ABSTRACT

A light guide panel (LGP), a backlight unit, and a display using the LGP are provided. The LGP includes: a first layer having an incident surface on which light emitted from a light source is incident, a surface opposite to the incident surface, and a top surface through which light exits; a second layer disposed on the first layer and including a periodic array of exit units, each exit unit having a concave portion and a convex prism; and a third layer of an anisotropic material disposed on the second layer, wherein light having a first polarization that is transmitted through the concave portion is totally reflected by the prism and is transmitted upward through the third layer, while light having a second polarization is totally reflected at a top surface of the third layer.

### CROSS-REFERENCE TO RELATED PATENT APPLICATIONS

This application claims the benefit of Korean Patent Application Nos. 10-2006-0013701 and 10-2006-0035364, filed on Feb. 13, 2006 and 19 Apr. 2006, respectively, in the Korean Intellectual Property Office, the disclosures of which are incorporated herein in their entirety by reference.

### BACKGROUND OF THE INVENTION

1. Field of the Invention

Apparatuses consistent with the present invention relate to a high output light guide panel (LGP) allowing both an amount of light exiting upwardly and an amount of light exiting perpendicularly to develop, a backlight unit employing the light guide panel, and a display employing the backlight unit.

2. Description of the Related Art

Liquid crystal displays (LCDs) used in notebooks, desktop computers, LCD-TVs, mobile communication terminals, and the like are non-emissive flat panel displays that selectively transmit light emitted externally to produce an image. Thus, a backlight unit emits light and is disposed behind an LCD and.

Backlight units are classified as direct light type backlight units or edge light type backlight units according to the position of the light source therein. In the case of a direct light type backlight unit, a lamp disposed beneath an LCD panel directly emits light onto the LCD panel.

Because a direct light type backlight unit allows a light source to be disposed freely and efficiently within a wide area, it is suitable for a display with a large screen of greater than 30 inches. Conversely, an edge light type backlight unit, wherein a light source is located within a restricted area such as a sidewall of an LGP, is suitable for a mid- and small-sized display used in monitors or cellular phones.

FIG. 1 illustrates an LGP used in a conventional edge light type backlight unit. The edge light type backlight unit includes a light source 10 and an LGP having a first layer 15 made of an isotropic material, a second layer 18 formed on the first layer 15, and a third layer 25 made of an anisotropic material. The first layer 15 has an incident surface 15a on which light emitted from the light source 10 is incident and an opposing surface 15b opposing the incident surface 15a.

The second layer 18 is an adhesion layer with a prism array 20. The third layer 25 is formed of a birefringent material having a variable refractive index depending on the polarization direction of incident light.

FIGS. 2A-2E illustrate the amount of light with respect to an angle of light exiting through the LGP of FIG. 1 when an angle θ₁ of a prism in the prism array 20 is 50°, 60°, 70°, 80°, and 90°, respectively. Graphs A and B respectively illustrate the amount of light in the X and Y directions indicated in FIG. 1. As evident from the graphs A and B, the largest amount of light exits orthogonal to the LGP when the prism angle θ₁ is 50°. As the amount of light exiting orthogonally with respect to the LGP increases, a throughput increases and light output from a backlight unit has a more uniform intensity distribution.

Table 1 illustrates the amount of light exiting through a top surface (Z direction) and the amount of light at the opposing surface 15b of the LGP when the incident amount of light with polarization exiting the LGP is 100.

TABLE 1

| | Prism angle (°) | | | | |
|---|---|---|---|---|---|
| | 50 | 60 | 70 | 80 | 90 |
| Light exiting | 50.61100 | 61.35100 | 69.33000 | 71.81500 | 67.61300 |
| through | | | | | |
| top surface | | | | | |
| Light at | 30.91300 | 22.88000 | 16.41000 | 14.15700 | 14.69100 |
| facing | | | | | |
| surface 15b | | | | | |

As evident from the Table 1, the amount of light exiting through the top surface of the LGP is largest when the prism angle is 80°.

The LGP having the above-mentioned configuration does not allow the largest amount of light to exit through a top surface and orthogonally with respect to the top surface under the same prism angle. That is, an optimum amount of light cannot exit perpendicularly when an optimum amount of light exits upwardly, or vice versa.

FIG. 3 illustrates an LGP without an adhesion layer used in a conventional edge light type backlight unit. Referring to FIG. 3, the conventional backlight unit includes a light source 50 and a LGP having a first layer 55 with a prism array 57 and a second layer 60 formed on the first layer 55. The first and second layers 55 and 60 are formed of isotropic and anisotropic materials, respectively.

FIGS. 4A-4E illustrate the amount of light with respect to an angle of light exiting through the LGP of FIG. 3 when an angle θ₂ of a prism in the prism array 57 is 50°, 60°, 70°, 80°, and 90°, respectively. Graphs A and B respectively illustrate the amount of light in the X and Y directions indicated in FIG. 3. As evident from the graphs A and B, the largest amount of light exits orthogonally toward the LGP when the prism angle θ₂ is 50°.

Table 2 illustrates the amount of light exiting through a top surface (Z direction) and a surface 55b opposite to an incident surface 55a of the LGP when the amount of incident light with polarization exiting the LGP is 100.

TABLE 2

| | Prism angle (°) | | | | |
|---|---|---|---|---|---|
| | 50 | 60 | 70 | 80 | 90 |
| Light exiting | 50.61100 | 61.35100 | 69.33000 | 71.81500 | 67.61300 |
| through | | | | | |
| top surface | | | | | |
| Light at | 30.91300 | 22.88000 | 16.41000 | 14.15700 | 14.69100 |
| facing | | | | | |
| surface 15b | | | | | |

As evident from Table 2, the LGP of FIG. 3 also does not allow the largest amount of light to exit both upwardly and perpendicularly. That is, the amount of light exiting upwardly is largest when the prism angle is 80° while the amount of light exiting perpendicularly is largest when the prism angle is 50°. As described above, conventional LGPs do not allow the largest amount of light to exit both upwardly and perpendicularly under the same prism angle.

### SUMMARY OF THE INVENTION

The present invention provides a high output LGP which allows the light to exit both upwardly and orthogonally, a backlight unit employing the LGP, and a display employing the backlight unit.

According to an exemplary embodiment of the present invention, there is provided an LGP comprising: a first layer comprising an incident surface on which light emitted from a light source is incident, a surface opposite to the incident surface, and a top surface through which light exits; a second layer disposed on the first layer and comprising a periodic array of exit units, each exit unit comprising a concave portion and a convex prism; and a third layer comprising an anisotropic material disposed on the second layer; wherein light having a first polarization that is transmitted through the concave portion is totally reflected by the convex prism and is transmitted upward through the third layer, while light having a second polarization is totally reflected at a top surface of the third layer.

The second layer may further comprise planar portions disposed between adjacent exit units. The concave portion may comprise a curved surface and a planar surface. The curved surface may have a circular cross-section. The concave portion may comprise at least two planar surfaces. The planar may be tapered away from the light source. The concave portion and the prism may repeat, forming a continuous array.

In another exemplary embodiment, an LGP comprises: a first layer comprising an incident surface on which light emitted from a light source is incident, a surface opposite to the incident surface, and a top surface through which light exits; a second layer that is disposed on the top surface of the first layer and comprises a periodic array of exit units, each exit unit having a first concave portion, a convex prism and a second concave portion continuously connected to the prism; and a third layer comprising an anisotropic material disposed on the second layer, wherein light having a first polarization that is transmitted through the first concave portion is totally reflected by the convex prism and is transmitted upwardly through the third layer, light having the first polarization that is transmitted through the second concave portion is totally reflected by an inside surface of the second concave portion and is transmitted upwardly through the third layer, and light having a second polarization is totally reflected at a top surface of the third layer.

According to another exemplary embodiment of the present invention, there is provided a backlight unit which irradiates a display with light, including: a light source; an LGP which guides light incident from the light source; and a prism sheet disposed above the LGP. The LGP comprises: a first layer comprising an incident surface on which light emitted from the light source is incident, a surface opposite the incident surface, and a top surface through which light exits; a second layer disposed on the first layer and comprising a periodic array of exit units, each exit unit comprising a concave portion and a convex prism; and a third layer comprising an anisotropic material disposed on the second layer. In the LGP, light having a first polarization that is transmitted through the concave portion is totally reflected by the convex prism and is transmitted upward through the third layer, while light having a second polarization is totally reflected at a top surface of the third layer.

In another exemplary embodiment, a backlight unit which illuminates a display with light comprises: a light source; an LGP which guides light incident from the light source; and a prism sheet disposed above the LGP. The LGP includes: a first layer comprising an incident surface on which light emitted from the light source is incident, a surface opposite to the incident surface, and a top surface through which light exits; a second layer disposed on the first layer and comprising a periodic array of exit units, each exit unit comprising a first concave portion, a convex prism and a second concave portion continuously connected to the prism; and a third layer comprising an anisotropic material disposed on the second layer. In the LGP, light having a first polarization that is transmitted through the first concave portion is totally reflected by the prism and is transmitted upwardly through the third layer, light having the first polarization that is transmitted through the second concave portion is totally reflected by an inside surface of the second concave portion and is transmitted upwardly through the third layer, and light having a second polarization is totally reflected at a top surface of the third layer.

According to another exemplary embodiment of the present invention, there is provided a display comprising: a light source; an LGP which guides light incident from the light source; a diffusion plate disposed above the LGP which transmits and diffuses incident light; and a display panel which produces an image using light supplied through the diffusion plate. The LGP comprises: a first layer comprising an incident surface on which light emitted from a light source is incident, a surface opposite to the incident surface, and a top surface through which light exits; a second layer disposed on the first layer and comprising a periodic array of exit units, each exit unit comprising a concave portion and a convex prism; and a third layer comprising an anisotropic material disposed on the second layer, wherein light having a first polarization that is transmitted through the concave portion is totally reflected by the convex prism and is transmitted upward through the third layer, while light having a second polarization is totally reflected at a top surface of the third layer.

### BRIEF DESCRIPTION OF THE DRAWINGS

The above and other exemplary aspects and advantages of the present invention will become more apparent by the following detailed description of exemplary embodiments thereof with reference to the attached drawings in which:

FIG. 1 illustrates a conventional LGP including an adhesion layer with a prism array;

FIGS. 2A-2E respectively illustrate the amount of light exiting perpendicularly through the LGP of FIG. 1, which is measured when an angle θ₂ of a prism in the prism array in the LGP is 50°, 60°, 70°, 80°, and 90°;

FIG. 3 illustrates a conventional LGP without an adhesion layer;

FIGS. 4A-4E respectively illustrate the amount of light exiting perpendicularly through the LGP of FIG. 3, which is measured when an angle θ₂ of a prism in the prism array in the LGP is 50°, 60°, 70°, 80°, and 90°;

FIG. 5 illustrates an LGP according to an exemplary embodiment of the present invention;

FIG. 6 is an enlarged view of the portion H in the LGP of FIG. 5;

FIG. 7 illustrates the amount of light exiting upwardly through the LGP of FIG. 5;

FIG. 8 illustrates the amount of light exiting perpendicularly through the LGP of FIG. 5;

FIGS. 9A and 9B illustrate processes of light exiting through the exit unit in the LGP of FIG. 5 and of light exiting through a prism according to a comparative example, respectively;

FIGS. 10A-10D illustrate various examples of the exit unit in the LGP of FIG. 5;

FIG. 11 illustrates an LGP with a polarization converting plate according to another exemplary embodiment of the present invention;

FIG. 12 illustrates an LGP according to another exemplary embodiment of the present invention;

FIG. 13 is an enlarged view of the portion J in the LGP of FIG. 12;

FIGS. 14A and 14B illustrate examples of the exit unit in the LGP of FIG. 12;

FIG. 15 illustrates a process of light exiting through the exit unit in the LGP of FIG. 12;

FIGS. 16A and 17A illustrate the amount of light exiting upwardly through the LGP of FIG. 12, which is measured by changing the central angle of the second concave portion of the exit unit in the LGP;

FIGS. 16B and 17B illustrate the amount of light exiting perpendicularly through the LGP of FIG. 12, which is measured by changing the central angle of the second concave portion of the exit unit in the LGP;

FIG. 18 illustrates an LGP with a polarization converting plate according to an exemplary embodiment of the present invention;

FIG. 19 illustrates a display employing an LGP according to an exemplary embodiment of the present invention; and

FIG. 20 illustrates a display employing the LGP of FIG. 12.

### DETAILED DESCRIPTION OF EXEMPLARY EMBODIMENTS OF THE INVENTION

A light guide panel (LGP), a backlight unit employing the LGP, and a display employing the backlight unit according to exemplary embodiments of the present invention will now be described in detail with reference to the accompanying drawings.

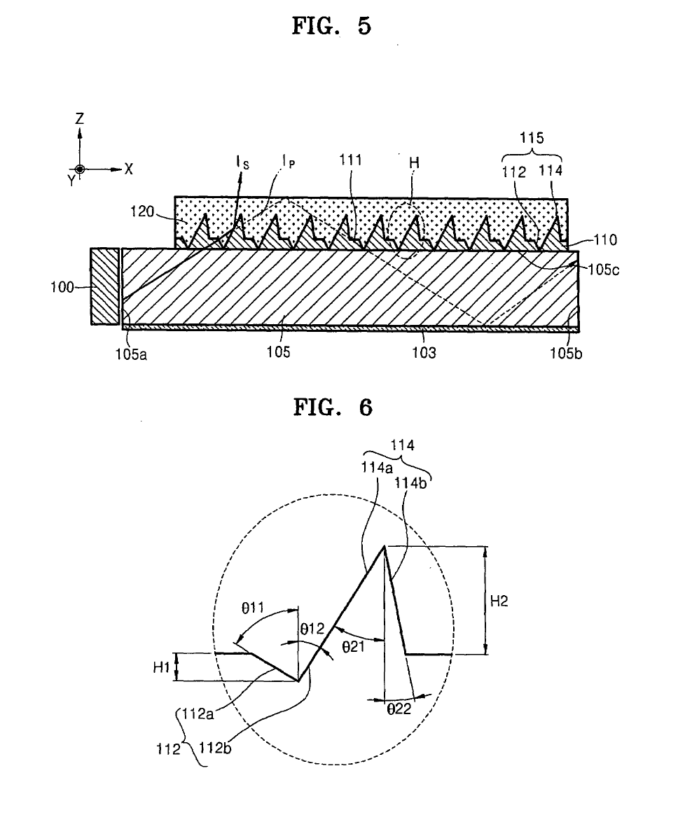

FIG. 5 illustrates an LGP according to an embodiment of the present invention. Referring to FIG. 5, the LGP includes a first layer 105 guiding light emitted from a light source 100, a second layer 110 formed on the first layer 105, and a third layer 120 made of an anisotropic material.

The first layer 105 has an incident surface 105a, an opposing surface 105b opposite to the incident surface 105b, and a top surface 105c through which light exits. A reflective plate 103 is disposed on a bottom surface of the first layer 105 and reflects light propagating toward the bottom surface of the first layer 105.

The second layer 110 has a continuous and periodic array of exit units 115, each exit unit 115 including a concave portion 112 and a convex prism 114, and planar portions 111 between adjacent exit units 115. A connecting portion between the concave portion 112 and the prism 114 is planar. The concave portion 112 has curved and planar surfaces or at least two planar surfaces. The exit unit 115 can be fabricated in various forms, which will be described in more detail later.

The third layer 120 made of the anisotropic material has different refractive characteristics depending on the polarization direction of incident light. In other words, the third layer 120 has birefringent characteristics, i.e., first and second refractive indices with respect to light beams of first and second polarizations. The anisotropic material may be PolyEthyleneTerephthalate (PET), PolyButylene-Terephthalate (PBT), or PolyEthyleneNaphthalate (PEN). The first and second layers 105 and 110 may be formed of an isotropic material having the same or almost the same refractive indices. For example, the first and second layers 105 and 110 may be formed of PMMA and resin having refractive indices of 1.49 and 1.5, respectively. The first and second layers 105 and 110 may be integrally formed of the same material. The third layer 120 may have a first refractive index that is almost equal to those of the first and second layers 105 and 110 with respect to a light beam of P polarization and a second refractive index with respect to a light beam of S polarization.

Thus, there is no difference in refractive indices at the interfaces between the layers when a light beam of P polarization propagates through the first through third layers 105, 110, and 120. The ideal case is when the refractive index of the first and second layers 105 and 110 is equal to the first refractive index of the third layer 120 and the second refractive index is greater than the first refractive index. In this case, the light beam of P polarization travels through the first through third layers as if passing through a single material.

Referring to FIG. 6, the exit unit 115 includes a concave portion 112 having a prism shape with first and second planar surfaces 112a and 112b and a convex prism 114 having third and fourth planar surfaces 114a and 114b. The second and third planar surfaces 112b and 114a are continuously connected to form a single planar surface.

In FIG. 5, the areas of second and third layers 110 and 120 are made smaller than that of the first layer 105 because a dark portion is formed on the top surface of the first layer 105, which is near the area of the incident surface 105a. That is, a screen excluding the dark portion is used as an effective screen. However, in the absence of the dark portion, the area of each of the first through third layers 105, 110, and 120 can be made equal.

The operation of the LGP having the above-mentioned configuration will now be described. A light beam emitted from the light source 100 is incident on the first layer 105 and is radiated in all directions. Light propagating downward is reflected upward by the reflective plate 103 and refracted through the second layer 110. Light incident on the second layer 110 passes through the planar portion 111 and the first through fourth surfaces 112a, 112b, 114a, and 114b and is incident on the third layer 120. The first and second layers 105 and 110 are made of isotropic materials and are not affected by the polarization direction of incident light, while light incident on the third layer 120 is refracted differently depending on the polarization direction of the light so that it propagates along different paths. When a first refractive index nₑ with respect to light I_{S} of first polarization is greater than a second refractive index nₒ with respect to light I_{P} of second polarization and that of the second layer 110, the light I_{S} of the first polarization and the light I_{P} of the second polarization separately propagate through the third layer 120. While the light I_{S} of the first polarization is incident on the third layer 120 at an angle less than a critical angle and then transmitted through a top surface of the third layer 120, the light I_{P} of the second polarization is incident on the top surface of the third layer 120 at an angle greater than the critical angle and then reflected from the top surface of the third layer 120. That is, most of the incident light I_{S} of the first polarization is transmitted at an angle that is almost orthogonal to the top surface of the third layer 120.

The light I_{P} of the second polarization is reflected downward from the top surface of the third layer 120. Most of the light I_{P} of the second polarization is refracted through the third and second layers 110 and 120 back into the first layer 105 because of a small difference in the refractive indices of the first through third layers 105, 110, and 120. When the light I_{P} of the second polarization passes through the first surface 112a into the second and third surfaces 112b and 114a, most of the light I_{P} of the second polarization is refracted back into the first layer 105 due to a small refractive index difference between the second and third layers 110 and 120.

On the other hand, when the light I_{S} of the first polarization is refracted through the first surface 112a into the second and third surfaces 112b and 114a, most of the incident light is totally reflected upward due to a large refractive index difference between the second and third layers 110 and 120. Because the totally reflected light propagates upward, the amount of light exiting perpendicularly with respect to the top surface of the third layer 120 is increased.

The LGP of the present embodiment allows the light beams of first and second polarizations to be separated by the third layer 120 made of an anisotropic material. Thus, when an LCD panel is used as a display, the structure of the display can be simplified. Because of its susceptibility to polarization characteristics of incident light, an LCD panel typically requires a polarizing film that extracts light of specific polarization for use. However, as described above, the LGP according to the present embodiment allows light of the second polarization to be reflected downward from the third layer 120 while allowing only light of the first polarization to exit through the top surface for effective use, thus eliminating the need for a separate polarizing film to obtain only light of specific polarization.

A light beam incident on the planar portion 111 among light propagating toward the second layer 110 is transmitted into the third layer 120, is then reflected from the top surface of the third layer 120 back into the first layer 105, and propagates toward the opposing surface 105b. The planar portion 111 allows light that is emitted from the light source 100 located along a sidewall of the LGP and then incident through the incident surface 105a to be reflected toward the opposing surface 105b. The planar portion 111 makes the distribution of light exiting upwardly uniform between the incident surface 105a and the opposing surface 105b. The planar portion 111 may be tapered away from the light source 100 in order to increase the amount of light reaching a portion thereof overlying the opposing surface 105b

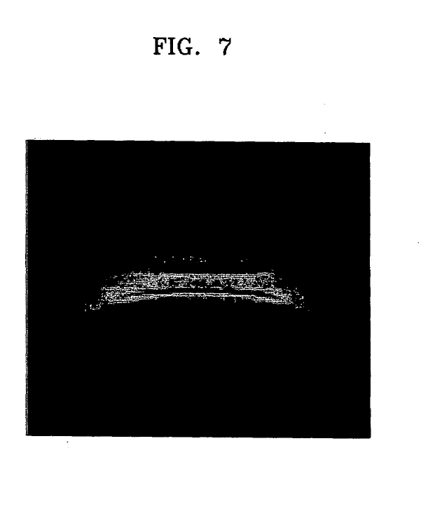

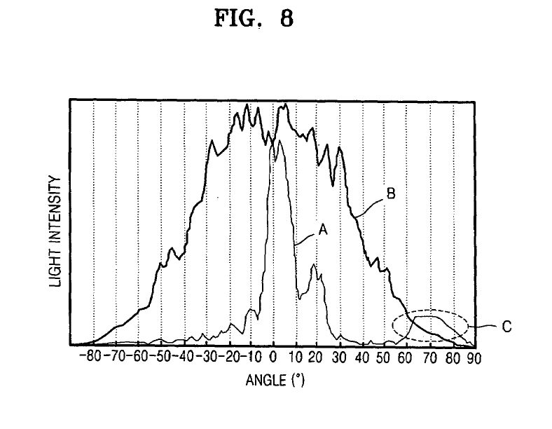

The amount of light exiting upwardly and perpendicularly can be adjusted by changing the shape of the exit unit 115 such as central angles θ11+θ12 and θ21+θ22 of the concave portion 112 and the prism 114. FIGS. 7 and 8 illustrate the amount of light exiting upwardly through the LGP and the range of angles at which light exits, respectively. In this case, θ11=65°, θ12=θ21=25°, θ22=20°, H1=50 μm, H2=50 μm, and pitch=80 μm. The pitch is a periodic distance between adjacent exit units that is equal to a distance between the apexes of adjacent prisms 114. The amount of light exiting through the top surface of the third layer 120 and through the opposing surface 105b are 70.03400 and 14.90300, respectively, when the amount of incident light with polarization exiting the LGP is 100.

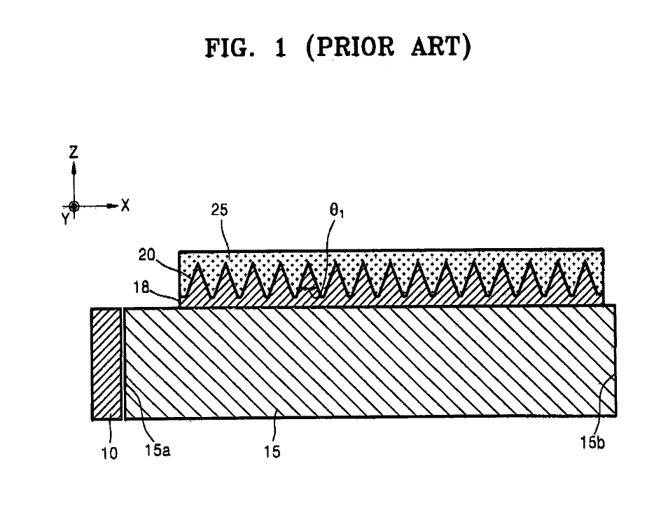

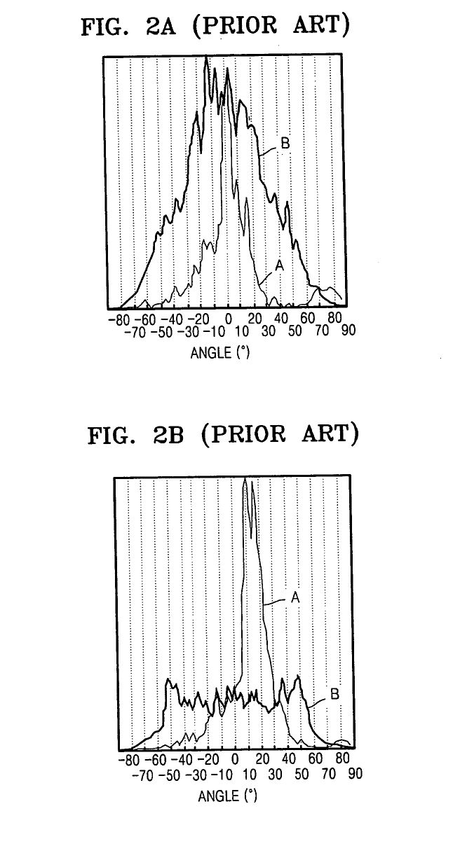

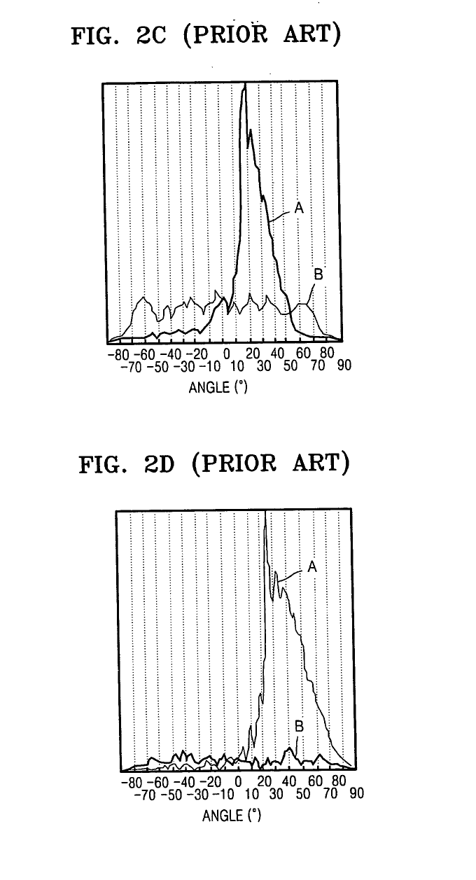

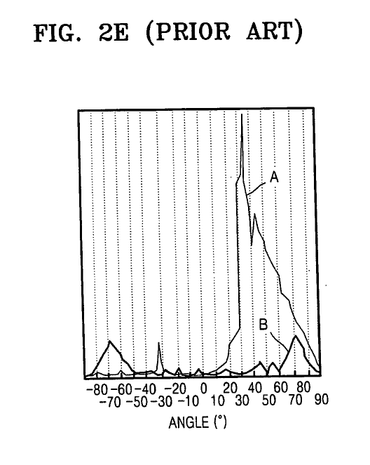

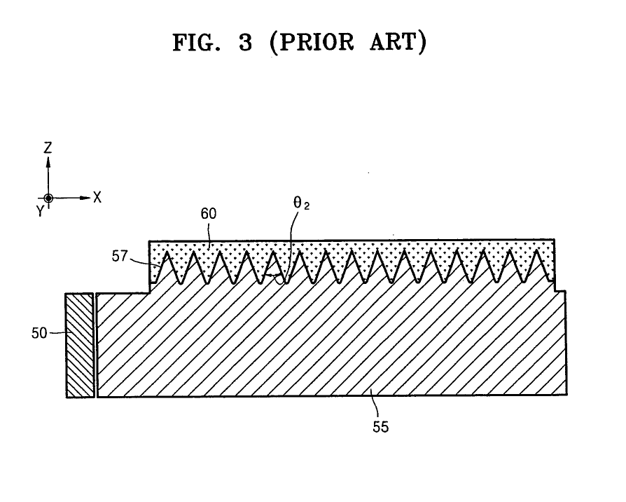

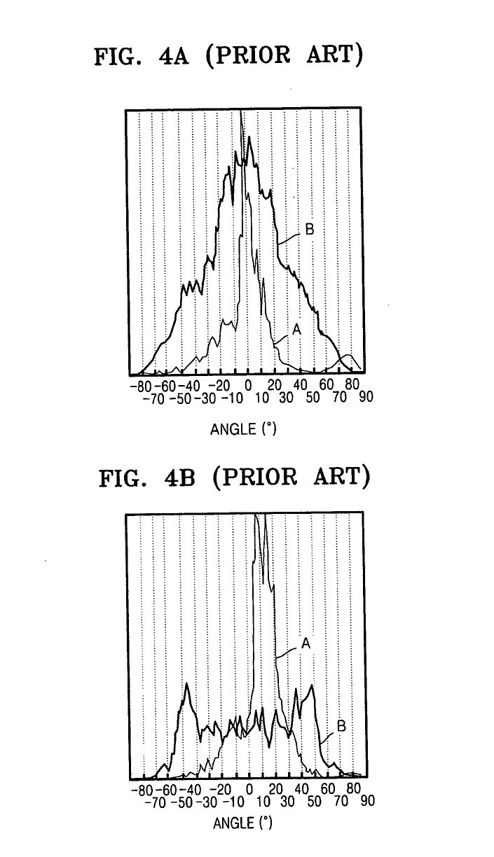

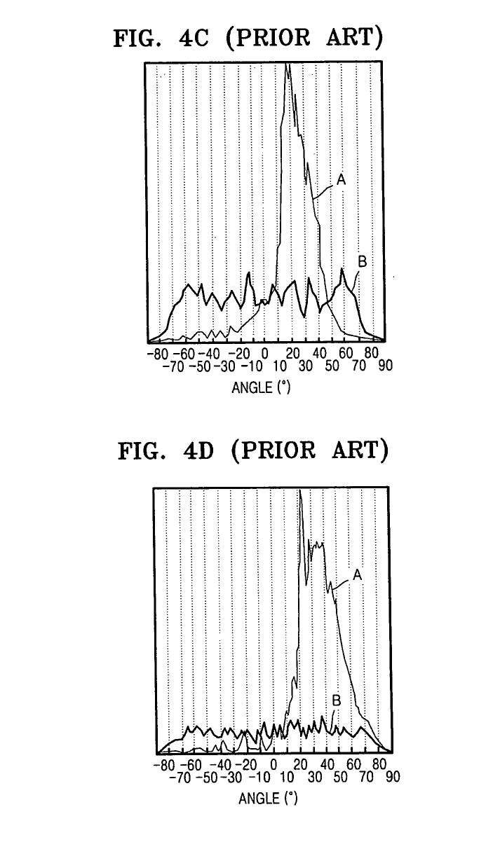

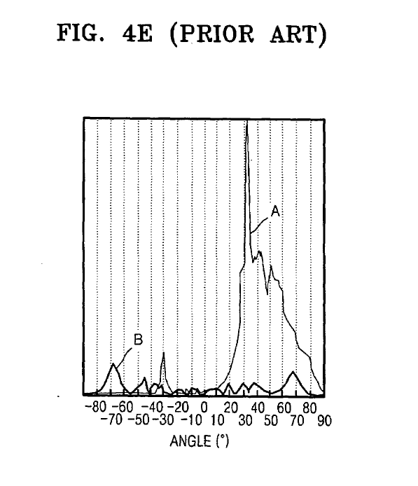

Graphs A and B in FIG. 8 respectively illustrate the ranges of angles at which light exits in the X and Y directions indicated in FIG. 5. As evident from the graph A, a large amount of light exits perpendicularly with respect to the top surface of the third layer 120. Furthermore, the amount of light exiting through the top surface of the third layer 120 is 70.03400 while the largest amount of light exiting upwardly through the conventional LGPs of FIGS. 1 and 3 is 71.81500. While the conventional LGPs of FIGS. 1 and 3 do not allow an optimum amount of light to exit perpendicularly when an optimum amount of light exits upwardly, or vice versa, the LGP of FIG. 5 according to the present invention allows the optimum amount of light to exit both upwardly and perpendicularly.

While the LGP of the present invention with exit units allows the optimum amount of light to exit both upwardly and perpendicularly, a conventional LGP with only prisms does not allow the optimum light to exit both upwardly and perpendicularly

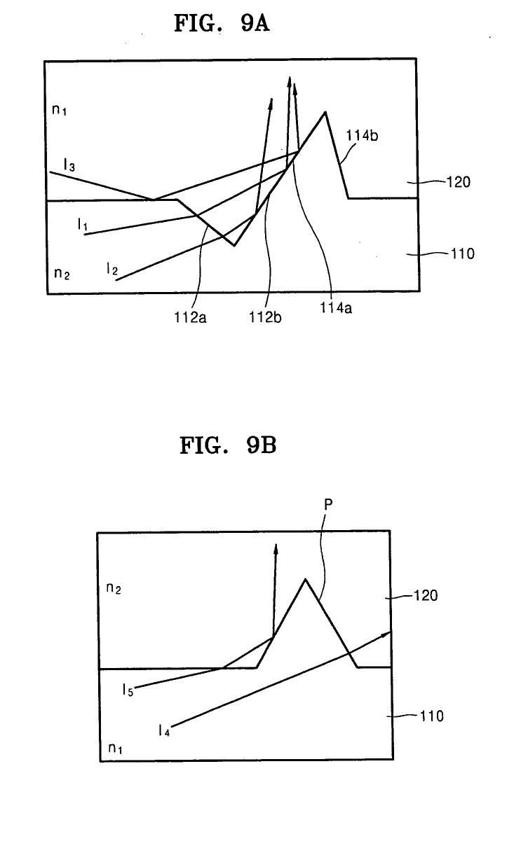

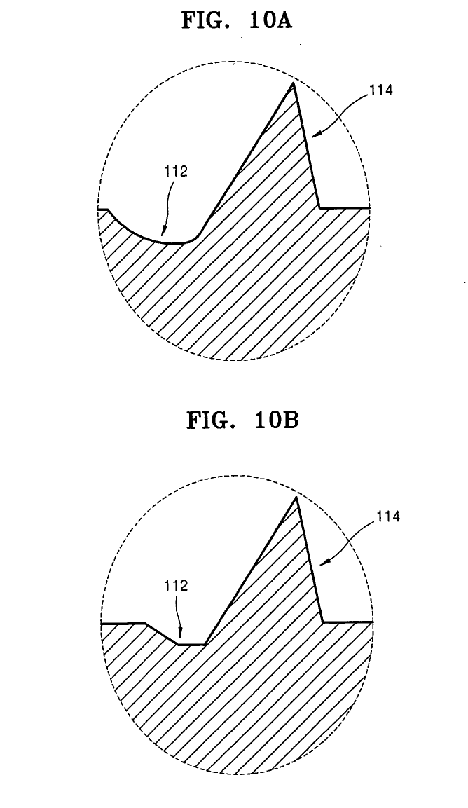

FIGS. 9A and 9B illustrate the structures of an exit unit according to the present invention and a prism P according to a comparative example. Because the LGP of the present invention allows only effective light of a specific polarization to exit due to polarization separation in the third layer 120 made of an anisotropic material having birefringence characteristics, the process of effective light of s polarization exiting through the LGP will now be described with reference to FIGS. 9A and 9B.

When n₁ and n₂ respectively denote the refractive indices of the second layer 110 and the third layer 120 with respect to light of S polarization, n₁<n₂. First and second light beams I₁ and I₂ incident through the first surface 112a among light propagating toward the second layer 110 are refracted into the second and third surfaces 112b and 114a. When the first and second light beams I₁ and I₂ are incident from a medium having a high refractive index n₂ to a medium having a low refractive index n₁ at an angle greater than a critical angle for total reflection, the incident light beams I₁ and I₂ are totally reflected.

Some of incident light is transmitted through the top surface of the third layer 120 while the remaining portion of the incident light is reflected downward from the top surface thereof. As a third light beam I₃ reflected from the top surface of the third layer 120 is incident the second layer 110, a portion of the third light beam I₃ is transmitted into the second layer 110 and the remaining portion of the third light beam I₃ is reflected to the second and third surfaces 112b and 114a. When the third light beam I₃ is incident on the second and third surfaces 112b and 114a at an angle greater than a critical angle, the incident light beam I₃ is totally reflected upward.

Most of the light incident on the second and third surfaces 112b and 114a through the first surface 112a of the concave portion 112 is totally reflected upward at an angle that is almost orthogonal to the top surface of the third layer 120.

On the other hand, in the structure having only the prism P illustrated in FIG. 9B, a portion of fourth light beam I₄ propagating from the second layer 110 toward the prism P is reflected while the remaining portion is refracted toward the third layer 120 at an angle that is relatively horizontal to the top surface of the third layer 120 and exits through the top surface of the third layer 120. Fifth light beam I₅ refracted through an interface between the second and third layers 110 and 120 without passing through the prism as it travels from the second layer 110 to the third layer 120 is incident on the prism P and reflected upward.

As evident from FIGS. 9A and 9B, the LGP according to the present invention allows most of light incident on the prism 114 through the concave portion 112 to be reflected upward from the second and third surfaces 112b and 114a so that the reflected light exit at an angle almost orthogonal to the top surface of the third layer 120. Conversely, the structure illustrated in FIG. 9B allows most of light refracted upward through the prism to propagate at an angle that is relatively horizontal to the top surface of the third layer 120.

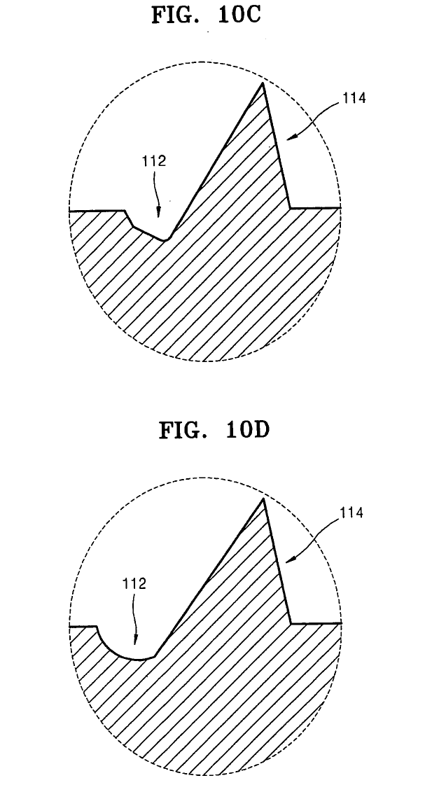

The concave portion 112 may have various shapes. For example, as illustrated in FIG. 6, the concave portion 112 may have a prism shape with two planar surfaces. Referring to FIG. 10A, the concave portion 112 may include a curved surface and at least one planar surface. Referring to FIG. 10B, the concave portion 112 may include a plurality of inclined planar surfaces and planar surfaces parallel to a horizontal direction. Referring to FIG. 10C, the concave portion 112 may have a plurality of planar surfaces inclined at different angles. Referring to FIG. 10D, the concave portion 112 may include a curved surface having a circular shape and a planar surface.

Use of the concave portion 112 allows light transmitted through the concave portion 112 to be incident on the prism 114 at an angle for total reflection and to be reflected by the prism at an angle almost orthogonal to the top surface of the third layer 120, thereby achieving a high output LGP.

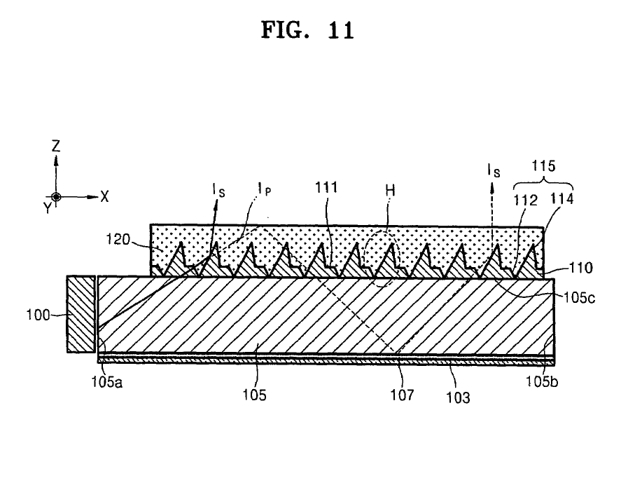

Referring to FIG. 11, the LGP according to the present invention may further include a polarization converting plate 107 in order to increase throughput. The polarization converting plate 107 is disposed between the first layer 105 and the reflective plate 103 and converts ineffective light I_{P} of the second polarization into effective light I_{S} of the first polarization by changing the polarization direction.

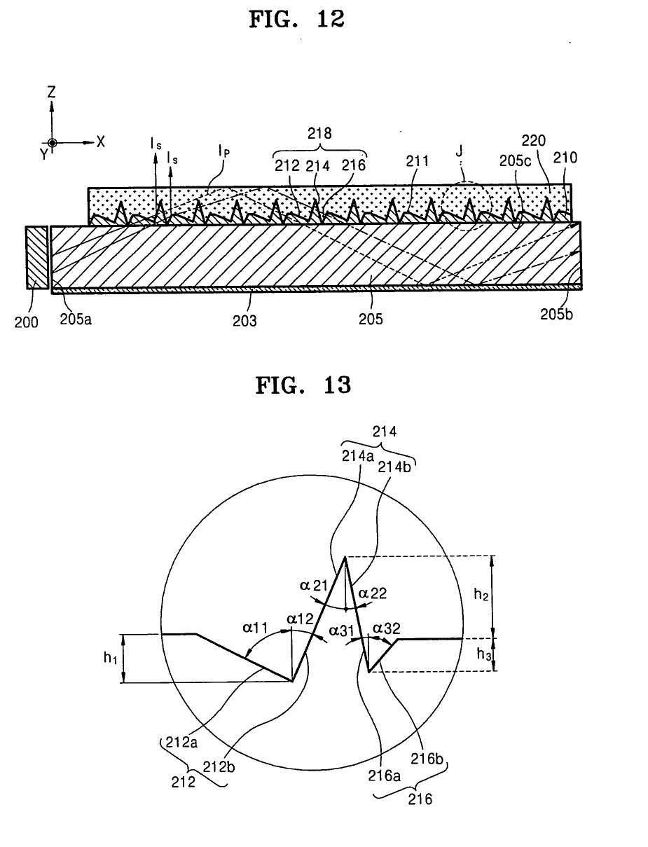

FIG. 12 illustrates a LGP according to another embodiment of the present invention. Referring to FIG. 12, the LGP includes a first layer 205 guiding light emitted from a light source 200, a second layer 210 formed on the first layer 205, and a third layer 220 made of an anisotropic material.

The first layer 205 has an incident surface 205a, a surface 205b opposite to the incident surface 205b, and a top surface 205c through which light exits. A reflective plate 203 is disposed on a bottom surface of the first layer 205 and reflects light propagating toward the bottom surface of the first layer 205.

The second layer 210 has a periodic array of exit units 218, each exit unit 218 including a first concave portion 212, a convex prism 214 and a second concave portion 216, and planar portions 211 between adjacent exit units 218. The third layer 220 made of the anisotropic material has different refractive characteristics depending on the polarization direction of incident light. In other words, the third layer 120 has birefringent characteristics, i.e., first and second refractive indices with respect to light beams of first and second polarizations. The first and second layers 205 and 210 may be formed of isotropic materials having the same or almost the same refractive indices. Because the operation of light with respect to the first through third layers 205, 201, and 220 is substantially the same as in the embodiment illustrated in FIG. 5, a detailed explanation thereof will not be given.

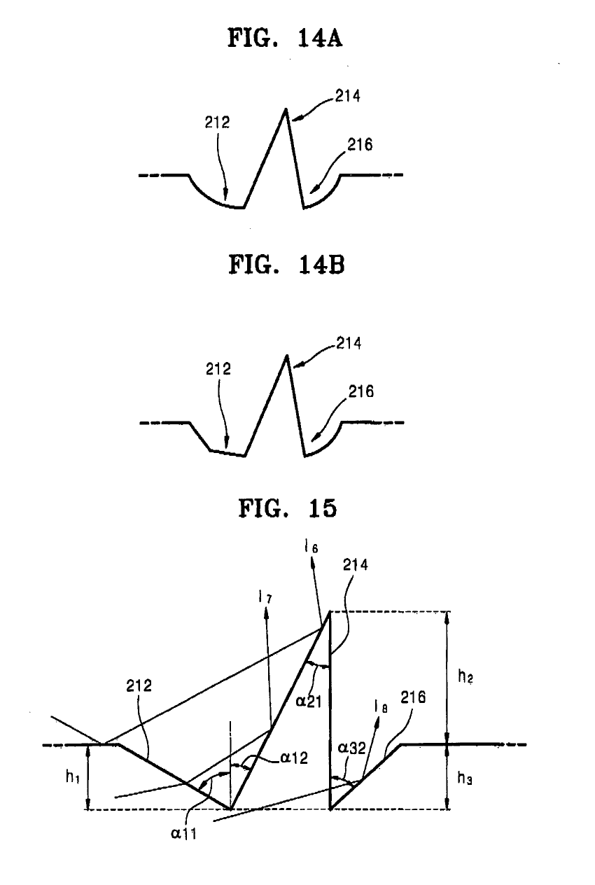

Referring to FIG. 13, the first concave portion 212 has at least two planar surfaces. For example, as illustrated in FIG. 6, the concave portion 112 may have a prism shape with two planar surfaces. Referring to FIGS. 14A and 14B, the first concave portion 212 may include at least one planar and curved surfaces. When the first concave portion 212 has a curved surface, the curved surface is located before a planar surface as shown in FIG. 14A. The second concave portion 216 may also have at least two planar surfaces or at least one planar and curved surfaces. When the second concave portion 216 has a curved surface, the curved surface is located behind the planar surface as shown in FIG. 14B.

Referring to FIG. 13, the first concave portion 212 includes first and second planar surfaces 212a and 212b, the prism 214 includes third and fourth planar surfaces 214a and 214b, and the second concave portion 216 includes fifth and sixth planar surfaces 216a and 216b. The second and third planar surfaces 212b and 214a are continuously connected to form a single planar surface and the fourth and fifth planar surfaces 214b and 216a are continuously connected to form a single planar surface. When h₁, h₂, and h₃ respectively denote the depth of the first concave portion 212, the height of the prism 214, and the depth of the second concave portion 216, h₁ and h₂ may have the same or different values or h₁ and h₃ may have the same value. Furthermore, the amount of light exiting upwardly and perpendicularly can be increased simultaneously by adjusting central angles of the first concave portion 212, the prism 214, and the second concave portion 216. The central angle α11+α12 of the first concave portion 212 may be greater than the central angle α31+α32 of the second concave portion 216.

Since the first concave portion 212 and the prism 214 perform substantially the same operation as their counterparts in FIG. 5, a detailed description thereof will not be given. The second concave portion 216 serves to reduce the amount of beams exiting at a large exiting angle among light exiting upwardly, thus increasing the amount of beams exiting orthogonally. In this case, the exiting angle is an angle between exiting beams and a normal line to the first layer 205. The beams exiting perpendicularly has an exiting angle close to 0°. Referring to FIG. 8, C denotes beams exiting at a large exiting angle among the light exiting upwardly. The second concave portion 216 allows the beams exiting at a large angle to be oriented almost orthogonally. That is, a light beam of first polarization among light that has passed through a fifth surface 216a is totally reflected upward from a sixth surface 216b and exits at an angle close to 90°.

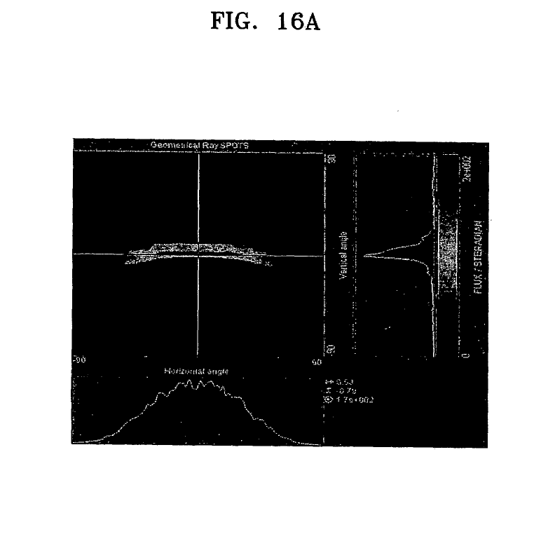

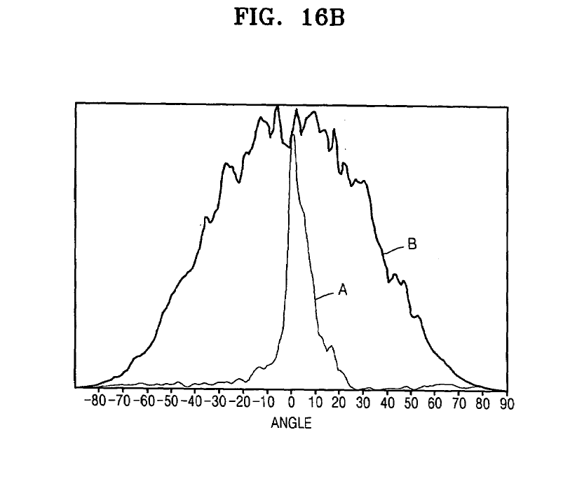

FIG. 15 illustrates an example of the prism 214 and the second concave portion 216 with a right-angled triangular cross-section. In other words, a plane formed by the meeting of the prism 214 and the second concave portion 216 is at a right angle with respect to the first layer 205. α22=0 in the prism 214 and α31=0 in the second concave portion 216. A portion 17 of light emitted from the light source 200 is reflected upward by the prism 214 while another portion I₈ of the light is totally reflected upward through the second concave portion 216. A portion I₆ of light that propagates toward the third layer 220 through the first and second layers 205 and 210 and then is reflected downward from the top surface 205c of the third layer 220 is totally reflected upward by the prism 214. FIGS. 16A and 16B illustrate distribution of light exiting upwardly when h₁=10 μm, h₂=50 μm, h₃=10 μm, θ11=65°, θ12=θ21=25°, θ22=θ31=0°, and θ32=25°. A distance (pitch) between adjacent prisms 214 is 60 μm. Graphs A and B in FIG. 16B respectively illustrate the ranges of angles at which light exits in the X and Y directions indicated in FIG. 12. the amount of light exiting upwardly and through the surface 205b are 70.50500 and 15.16300, respectively, when the amount of incident light is 100. As evident from the graph A of FIG. 16B, the amount of light exiting at a large angle (“C” in FIG. 8) is significantly reduced and a peak value of the intensity of exiting light is increased compared to corresponding values in FIG. 8.

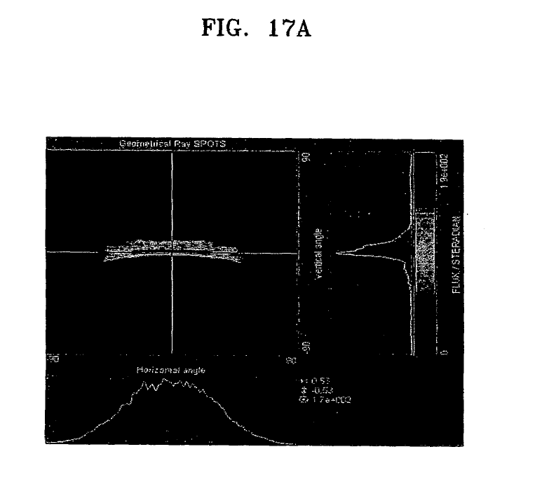

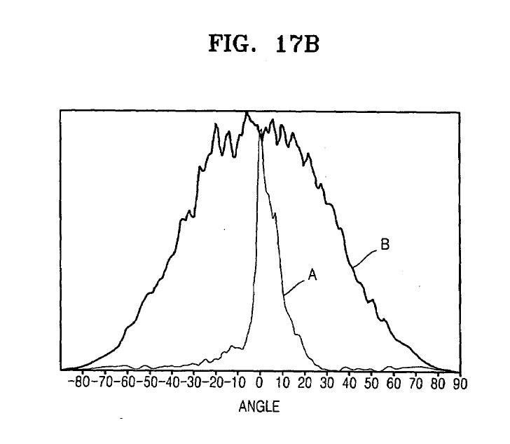

FIGS. 17A and 17B illustrate distribution of light exiting upwardly when h₁=10 μm, h₂=50 μm, h₃=10 μm, θ11=65°, θ12=θ21=25°, θ22=θ31=0°, θ32=30°, and a pitch is 60 μm. The amount of light exiting upwardly and through the surface 205b are 71.14000 and 14.75700, respectively, when the amount of incident light is 100. As evident from graph A of FIG. 17B, the amount of light exiting at a large angle is significantly reduced and a peak value of the intensity of exiting light is increased compared to corresponding values in FIG. 8. In this way, the presence of the second concave portion 216 increases the bandwidth and intensity of light exiting orthogonally.

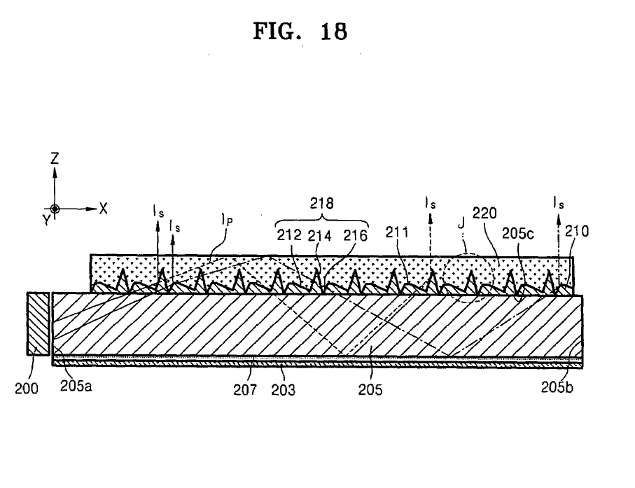

FIG. 18 illustrates an example of an LGP further including a polarization converting plate 207 disposed between the first layer 205 and the reflective plate 203 in addition to the structure of FIG. 12. The polarization converting plate 207 converts ineffective light I_{P} of second polarization into effective light I_{S} of first polarization by changing the polarization direction, thus increasing throughput.

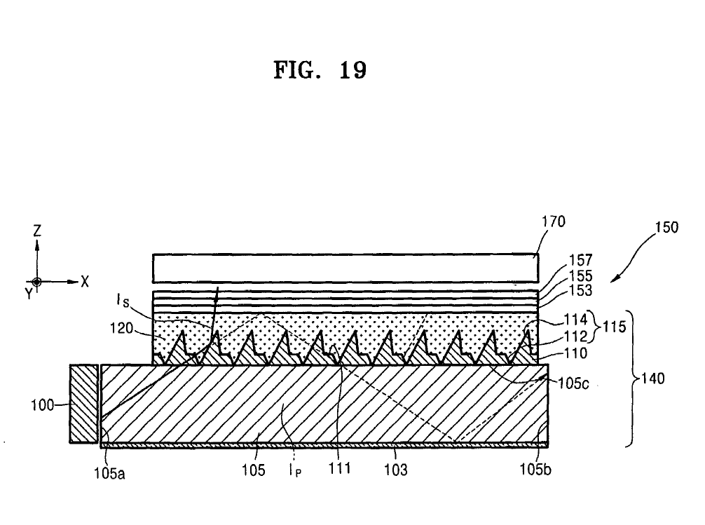

FIG. 19 illustrates a display employing an LGP according to an embodiment of the present invention. Referring to FIG. 19, the display includes a backlight unit 150 and a display panel 170 producing an image using light emitted from the backlight unit 150. The backlight unit 150 includes a light source 100 and an LGP 140 guiding light emitted from the light source 100 toward the display panel 170. Because the LGP 140 has the same configuration and performs the same operation as described above, a detailed description thereof will not be given.

The backlight unit 150 further includes a diffusion plate 153 diffusing light, a first prism sheet 155 correcting the propagation path of light and a second prism sheet 157 disposed between the LGP 140 and the display panel 170. The first and second prism sheets are orthogonal to each other and refract and focus light output from the diffusion plate 153 in order to improve the directionality of the light, thus increasing the light brightness and reducing the incident angle of light. Optical sheets and components disposed between the LGP 140 and the display panel 170 can exhibit better performance when they can conserve polarization.

For example, the display panel 170 may be a LCD panel. The LCD panel uses only light of specific polarization as effective light. An LGP according to the present invention allows light to be separated into light beams having different polarizations according to the polarization direction and only a light beam having specific polarization to be directed upward from the third layer 120, thus eliminating the need for a separate polarizing film for separating polarizations. The backlight unit 150 may further include the polarization converting plate 107 as shown in FIG. 11 disposed between the first layer 105 and the reflective plate 103.

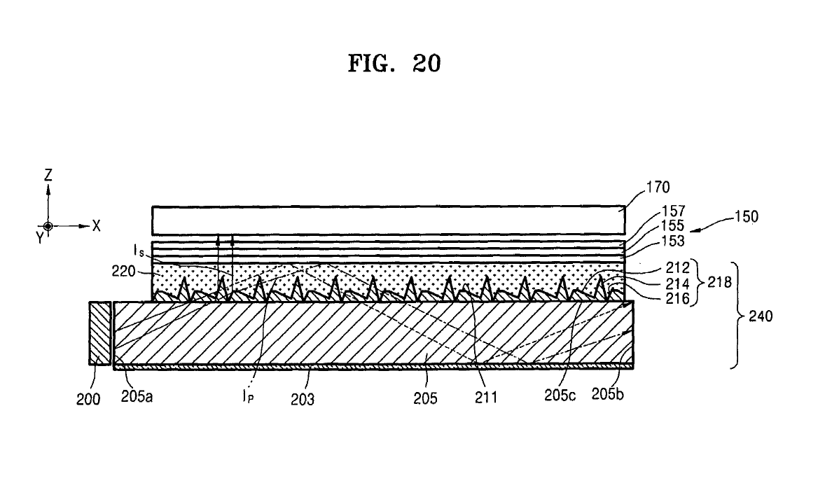

FIG. 20 illustrates a display employing an LGP according to another embodiment of the present invention. Referring to FIG. 20, the display includes a backlight unit 150 and a display panel 170 producing an image using light emitted from the backlight unit 150. The backlight unit 150 includes a light source 100 and an LGP 240 guiding light emitted from the light source 100 toward the display panel 170. The LGP 240 has the same configuration and performs the same operation as the LGP of FIG. 12. Like reference numerals in FIGS. 12 and 20 denote like elements, and thus their descriptions will be omitted. The backlight unit 150 may further include the polarization converting plate 207 as shown in FIG. 18 in order to increase throughput.

As described above, an LGP according to the present invention includes an exit unit including a concave portion and a prism to increase the amount of light exiting both upwardly and perpendicularly, thus achieving a high output power.

A backlight unit employing an LGP according to the present invention and a display employing the backlight unit provide a high brightness and good image quality screen. The display of the present invention includes a layer of an anisotropic material in a top portion of the LGP, which can separate light according to polarization components and allow only a light beam of one polarization to exit through a top surface thereof, thus eliminating the need for a separate polarizing film.

The LGP according to the present invention includes an exit unit having concave portions disposed in front of and behind a prism to allow light directed upward at a large angle to exit perpendicularly, thus increasing the amount of light exiting upwardly and perpendicularly.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A light guide panel comprising:
a first layer comprising
an incident surface on which light emitted from a light source is incident,
an opposing surface opposite to the incident surface, and
a top surface through which light exits;
a second layer disposed on the top surface of the first layer and comprising a periodic array of exit units, each exit unit comprising a concave portion and a convex prism; and
a third layer comprising an anisotropic material disposed on the second layer,
wherein light having a first polarization that is transmitted through the concave portion, is totally reflected by the convex prism and is transmitted upward through the third layer, while light having a second polarization is totally reflected at a top surface of the third layer.

2. The light guide panel of claim 1, wherein the second layer further comprises planar portions disposed between adjacent exit units.

3. The light guide panel of claim 1, wherein the concave portion comprises a curved surface and a planar surface.

4. The light guide panel of claim 3, wherein the curved surface has a circular-arc-shaped cross-section.

5. The light guide panel of claim 1, wherein the concave portion comprises at least two planar surfaces.

6. The light guide panel of claim 2, wherein the planar portion is tapered away from the light source.

7. The light guide panel of claim 1, wherein the concave portion and the prism repeat, forming a continuous array.

8. The light guide panel of claim 1, wherein the concave portion allows light passing therethrough to be incident on the convex prism at an angle greater than a critical angle for the convex prism.

9. The light guide panel of claim 1, wherein the first layer and the second layer comprise a single, integral body.

10. A light guide panel comprising:
a first layer comprising
an incident surface on which light emitted from a light source is incident,
a surface opposing the incident surface, and
a top surface through which light exits;
a second layer disposed on the top surface of the first layer and comprising a periodic array of exit units, each exit unit having a first concave portion, a convex prism, and a second concave portion continuously connected to the prism; and
a third layer comprising an anisotropic material disposed on the second layer, wherein
light having a first polarization that is transmitted through the first concave portion, is totally reflected by the convex prism and is transmitted upwardly through the third layer,
light having the first polarization that is transmitted through the second concave portion, is totally reflected by an inside surface of the second concave portion and is transmitted upwardly through the third layer, and
light having a second polarization is totally reflected at a top surface of the third layer.

11. The light guide panel of claim 10, wherein the first and second concave portions have triangular cross-sections.

12. The light guide panel of claim 11, wherein a central angle of the first concave portion is greater than a central angle of the second concave portion.

13. The light guide panel of claim 11, wherein a plane is formed by the meeting of the prism and the second concave portion and is at a right angle to the first layer.

14. The light guide panel of claim 10, wherein the second concave portion comprises planar and curved surfaces.

15. The light guide panel of claim 14, wherein the prism and the second concave portion form a plane in a connecting area.

16. The light guide panel of claim 15, wherein the plane is at a right angle to the first layer.

17. The light guide panel of claim 10, wherein the second layer further comprises planar portions disposed between adjacent exit units.

18. A backlight unit irradiating a display with light, the backlight unit comprising:
a light source;
a light guide panel which guides light incident from the light source; and
a prism sheet disposed above the light guide panel;
wherein the light guide panel comprises:
a first layer comprising an incident surface on which light emitted from a light source is incident, a surface opposite to the incident surface, and a top surface through which light exits;
a second layer disposed on the top surface of the first layer and comprising a periodic array of exit units, each exit unit comprising a concave portion and a convex prism; and
a third layer comprising an anisotropic material disposed on the second layer,
wherein light having a first polarization that is transmitted through the concave portion, is totally reflected by the convex prism and is transmitted upward through the third layer, while light having a second polarization is totally reflected at a top surface of the third layer.

19. The backlight unit of claim 18, wherein the second layer further comprises planar portions disposed between adjacent exit units.

20. The backlight unit of claim 18, wherein the concave portion comprises a curved surface and a planar surface.

21. The backlight unit of claim 20, wherein the curved surface has a circular-arc-shaped cross-section.

22. The backlight unit of claim 18, wherein the concave portion comprises at least two planar surfaces.

23. The backlight unit of claim 19, wherein the planar portion is tapered away from the light source.

24. The backlight unit of claim 18, wherein the concave portion and the prism repeat, forming a continuous array.

25. The backlight unit of claim 18, wherein the concave portion allows light passing therethrough to be incident on the convex prism at an angle greater than a critical angle for the convex prism.

26. A backlight unit irradiating a display with light, the backlight unit comprising:
a light source;
a light guide panel which guides light incident from the light source; and
a prism sheet disposed above the light guide panel;
wherein the light guide panel comprises:
a first layer comprising an incident surface on which light emitted from a light source is incident, a surface opposite to the incident surface, and a top surface through which light exits;
a second layer disposed on the top surface of the first layer and comprising a periodic array of exit units, each exit unit having a first concave portion, a convex prism and a second concave portion continuously connected to the prism; and
a third layer comprising an anisotropic material disposed on the second layer, wherein
light having a first polarization that is transmitted through the first concave portion is totally reflected by the convex prism and is transmitted upwardly through the third layer,
light having the first polarization that is transmitted through the second concave portion is totally reflected by an inside surface of the second concave portion and is transmitted upwardly through the third layer, and
light having a second polarization is totally reflected at a top surface of the third layer.

27. The backlight unit of claim 26, wherein the first and second concave portions have triangular cross-sections.

28. The backlight unit of claim 27, wherein a central angle of the first concave portion is greater than a central angle of the second concave portion.

29. The backlight unit of claim 27, wherein a plane is formed by the meeting of the prism and the second concave portion and is at a right angle to the first layer.

30. The backlight unit of claim 26, wherein the second concave portion comprises planar and curved surfaces.

31. The backlight unit of claim 30, wherein the prism and the second concave portion form a plane in a connecting are, the plane forming a right angle with respect to the first layer.

32. The backlight unit of claim 26, wherein the light guide panel further comprises a polarization converting plate, disposed on a bottom surface of the first layer, which converts the polarization direction of incident light.

33. A display comprising:
the backlight unit of claim 18; and
a display panel which produces an image using light emitted from the backlight unit.

34. A display comprising:
the backlight unit of claim 26; and
a display panel which produces an image using light emitted from the backlight unit.
